(19) United States
(12) Patent Application Publication
(10) Pub. No.: US 2003/0115499 A1
(43) Pub. Date: Jun. 19, 2003

(54) Electronic data exchange platform fault warning system and method and a file reception/sending record data structure therefor

(75) Inventor: Yuan-Chau Chan, Taipei (TW)

Correspondence Address: Finnegan, Henderson, Farabow,, Garrett & Dunner, L.L.P., 1300 I Street, N.W., Washington, DC, 20005-3315, US

(73) Assignee: INVENTEC CORPORATION

(21) Appl. No.: 10/161,654

(22) Filed: Jun. 5, 2002

(30) Foreign Application Priority Data
Dec. 17, 2001 (TW) 90131204

(51) Int. Cl. H04L 1/22

(52) U.S. Cl. 714/4

(57) ABSTRACT

An electronic data exchange platform fault warning system and method with a file reception/sending record data structure therefor is proposed, which is devised for use with an electronic data exchange (EDI) platform for the purpose of automatically detecting whether the EDI platform operates normally, and in the event of an EDI fault condition, generating a warning signal to inform EDI system administrators or related personnel to carry out necessary maintenance work. The proposed system and method functions in such a manner that if the EDI platform sends or receives no EDI files for an exceedingly long time duration, then a warning message is promptly generated and transferred to a pre-specified group of EDI-related workstations and/or portable communication devices. Any one who sees the warning message first can then immediately notify the maintenance personnel to perform maintenance work on the faulted EDI platform.

### BACKGROUND OF THE INVENTION

1. Field of the Invention

This invention relates to information technology for electronic commerce, and more particularly, to an electronic data exchange platform fault warning system and method, and a file reception/sending record data structure therefor, which is intended for use with an electronic data exchange (EDI) platform for the purpose of automatically detecting whether the EDI platform operates normally, and in the event of an EDI fault condition, generating a warning signal to inform EDI system administrators or related personnel to carry out necessary maintenance work.

2. Description of Related Art

EDI (Electronic Data Exchange) is a well-known and widely utilized electronic commerce standard in the business world for business-to-business (B2B) communications via a network system, such as Internet. For data exchange purpose, the EDI standard provides a set of electronic transaction forms, including, for example, EDI-850 for purchase order, EDI-856 for advance shipment notification, EDI-810 for invoice, to name just a few.

Since the EDI standard is well-known in the field of information technology, description thereof will not be further detailed in this specification.

To implement the EDI technology, it is required to install an EDI program on an Internet-linked computer unit (hereinafter referred to as “EDI platform”), which is responsible for sending and receiving EDI files to and from customers.

Conventional EDI platforms are typically provided with network monitoring capability for detecting whether the EDI functionality operates normally, and in the event of an EDI fault condition, generating a warning signal to inform EDI system administrators or related personnel to carry out necessary maintenance work.

One drawback to the conventional network monitoring capability on EDI platforms, however, is that, in the event that a fault condition occurs at the ERP (Enterprise Resource Planning) module, or the IDOC (Information Day Organizing Committee) module, or the translator module, it is unable to detect such a fault condition, causing the EDI platforms unable to send or receive EDI files normally via the Internet.

One solution to the forgoing problem is to monitor the EDI system by all EDI-related users and system administrators, and in the event of an EDI fault condition, anyone who sees the fault condition first can notify maintenance personnel to perform maintenance work immediately. One drawback to this solution, however, is that not every company can have users or system administrators stand by the EDI platform for all day long; and therefore, in the event of an EDI fault condition occurs at the time when no one is at work with EDI transaction, such as during night, holiday, off-duty hours, and so on, it will cause the EDI platform unable to receive incoming EDI files from the customer, thus undesirably affect the business transaction with the customer.

### SUMMARY OF THE INVENTION

It is therefore an objective of this invention to provide an EDI platform fault warning system and method, and a file reception/sending record data structure therefor, which is capable of automatically detecting whether the EDI platform operates normally, and in the event of an EDI fault condition, generating a warning signal to inform EDI system administrators or related personnel to carry out necessary maintenance work.

The EDI platform fault warning system and method according to the invention is based on the concept that if the EDI platform sends or receives no EDI files for an exceedingly long time duration, such as 2 hours, then it can be concluded that the EDI platform might be faulted. This time duration can be predetermined based on the history of the date/time data of all incoming and outgoing EDI files by the EDI platform. For example, if the date/time data shows that the EDI platform receives at least one EDI file in one hour during past operation, it can be concluded that if the EDI platform hasn't received any EDI file for more than 2 hours, the EDI platform is highly probable to have faulted.

In one preferred embodiment, the warning message can be transferred in Email form via the company's Intranet system to a pre-specified group of EDI-related workstations, and/or further transferred via a wireless network interface to a pre-specified portable communication devices, such as PDA (personal digital assistant), that are carried by EDI system administrators on the go. Any one working at the EDI-related workstations or with the portable communication devices who sees the warning message first can then immediately notify the maintenance personnel to perform maintenance work on the faulted EDI platform.

Compared to the prior art, the EDI platform fault warning system and method of the invention can be implemented without having to use human labor to monitor whether the EDI platform operates normally, and in the event of an EDI fault condition, capable of automatically generating a warning signal to inform all EDI system administrator and EDI-related workers to carry out necessary maintenance work. This allows any fault condition in the EDI platform to be alerted immediately so that maintenance can be carried out promptly.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the system architecture of the EDI platform fault warning system according to the invention;

FIG. 2 is a flow diagram showing the procedural steps carned out by the EDI platform fault warning system and method according to the invention during operation; and

FIG. 3 is a schematic diagram showing the data structure of a file reception/sending record utilized by the EDI platform fault warning system and method of the invention.

### DETAILED DESCRIPTION OF PREFERRED EMBODIMENTS

The EDI platform fault warning system and method according to the invention is disclosed in full details in the following with reference to the accompanying drawings.

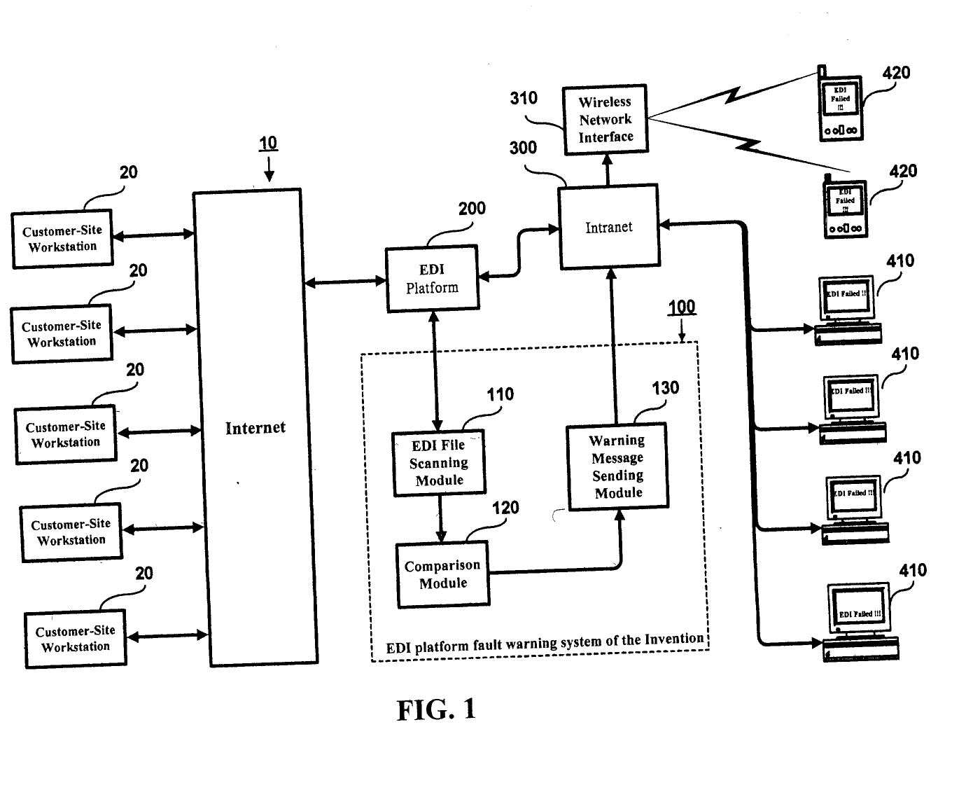

FIG. 1 is a schematic diagram showing the system architecture of the EDI platform fault warning system of the invention (as the part enclosed in the dotted box indicated by the reference numeral 100), which is integrated to an EDI platform 200 and an Internet/Intranet system including the Internet 10 and an Intranet system 300.

The EDI platform 200 is linked via the Internet 10 to a number of outside customer-site workstations 20 and via the Intranet system 300 to a number of EDI-related workstations 410, for the purpose of allowing these workstations 410 to exchange EDI files, such as EDI-850 purchase order, EID-856 advance shipment notification, EDI-810 invoice, and so on, via the Internet 10 with the customer-site workstations 20.

The EDI platform fault warning system of the invention 100 comprises: (a) an EDI file scanning module 110; (b) a comparison module 120; and (c) a warning message sending module 130.

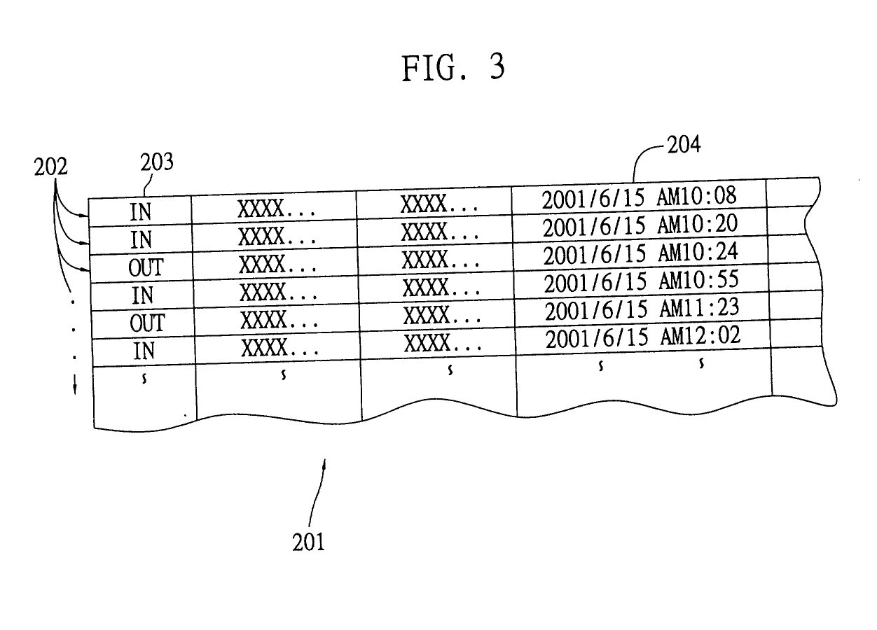

The EDI file scanning module 110 is capable of scanning an EDI file reception/sending record 201 in the EDI platform 200 to find the most-recently received or transmitted EDI file. The data structure of this EDI file reception/sending record 201 is shown in FIG. 3, by which each incoming or outgoing EDI file is registered in the EDI file reception/sending record 201 with the date/time when it was received or transmitted; and therefore, the most-recently received or transmitted EDI file can be found by comparing the date/time of each of the EDI files in the EDI file reception/sending record 201.

The comparison module 120 is capable of comparing the date/time of the most-recently received or transmitted EDI file against the current date/time to check whether the difference therebetween exceeds a predetermined time length, such as 2 hours. If YES, the comparison module 120 will output a trigger signal to the warning message sending module 130.

The warning message sending module 130 is capable of generating a warning message in response to the trigger signal from the comparison module 120, and transferring this warning message via the Intranet system 300 to all the EDI-related workstations 410, and/or further transferring the warning message via a wireless network interface 310 to a group of portable communication devices 420, such as PDA (personal digital assistant), that are carried by EDI system administrators on the go. The warning message sending module 130 can be, for example, an Email server, which is preset to send the warning message to a group of EDI-related recipients including system administrators and all the users who work with the EDI-based transaction with customers, so that any one of these people who sees the warning message first can immediately notify the maintenance personnel to perform necessary maintenance work on the faulted EDI platform 200.

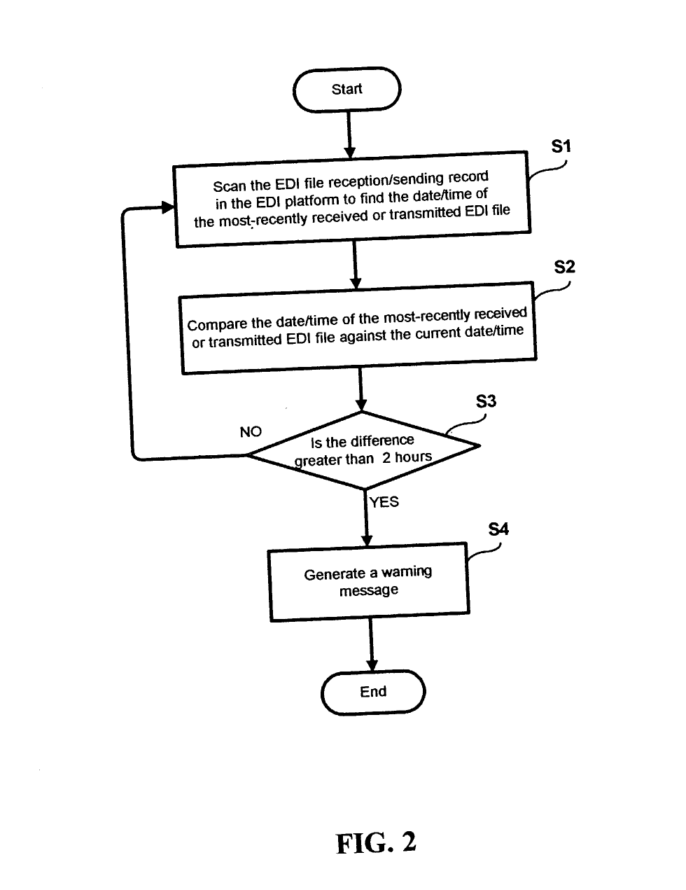

FIG. 2 is a flow diagram showing the procedural steps carried out by the EDI platform fault warning system of the invention 100 during operation.

As shown, in the first step S1, the EDI file scanning module 110 is activated at a preset interval to scan the EDI file reception/sending record 201 in the EDI platform 200 to find the date/time of the most-recently received or transmitted EDI file.

In the next step S2, the EDI file scanning module 110 transfers the parameter of the date/time of the most-recently received or transmitted EDI file to the comparison module 120 for comparison against the current date/time.

In the next step S3, the comparison module 120 compares the date/time of the most-recently received or transmitted EDI file against the current date/time to check whether the difference therebetween exceeds a predetermined time length, for example 2 hours. If NO, the procedure returns to step S1; whereas if YES, the comparison module 120 outputs a trigger signal to the warning message sending module 130.

In the next step S4, the warning message sending module 130 sends out a warning message in response to the trigger signal from the comparison module 120, and transfers this warning message via the Intranet system 300 to all the EDI-related workstations 410, and further transfers the warning message via the wireless network interface 310 to the portable communication devices 420 that are carried by EDI system administrators on the go. Any one working at the EDI-related workstations 410 or with the portable communication devices 420 who sees the warning message first can then immediately notify the maintenance personnel to perform maintenance work on the faulted EDI platform 200.

FIG. 3 is a schematic diagram showing the data structure of the EDI file reception/sending record 201 in the EDI platform 200. The EDI file reception/sending record 201 is pre-installed on the EDI platform 200 and stored in the backup folder (not shown) of the EDI platform 200. As shown, the EDI file reception/sending record 201 includes an incoming/outgoing indication field 203 and a date/time indication field 204. As the EDI platform 200 handles an incoming or outgoing EDI file 202, such as EDI-850 purchase order, EID-856 advance shipment notification, or EDI-810 invoice, the incoming/outgoing nature is registered in the incoming/outgoing indication field 203, with “IN” indicating that the EDI file 202 is incoming, and “OUT” indicating that the EDI file 202 is outgoing, and the date/time of the EDI file 202 is registered in the date/time indication field 204. By scanning the date/time indication field 204 of the EDI file reception/sending record 201, the EDI platform fault warning system of the invention 100 is able to find the date/time of the most-recently received or transmitted EDI file to thereby determine whether the EDI platform 200 operates normally.

Compared to the prior art, the EDI platform fault warning system and method of the invention can be implemented without having to use human labor to monitor whether the EDI platform operates normally, and in the event of an EDI fault condition, capable of automatically generating a warning signal to inform all EDI system administrator and EDI-related workers to carry out necessary maintenance work. This allows any fault condition in the EDI platform to be alerted immediately so that maintenance can be carried out promptly. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for use on an EDI platform for detecting whether the EDI platform operates normally, and in the event of a fault condition on the EDI platform, generating a warning signal;
the method comprising the steps of:
(1) installing an EDI file reception/sending record in the EDI platform, which indicates the date/time of each received or transmitted EDI file by the EDI platform;
(2) during operation of the EDI platform, scanning the EDI file reception/sending record at a preset interval to find the date/time of the most-recently received or transmitted EDI file by the EDI platform; and
(3) comparing the date/time of the most-recently received or transmitted EDI file against the current date/time to check whether the difference therebetween exceeds a predetermined time length; if YES, generating a warning message.

2. The method of claim 1, wherein in said step (1), the data structure of the EDI file reception/sending record includes:
an incoming/outgoing indication field for indicating the incoming/outgoing nature of each received or transmitted EDI file by the EDI platform; and
a date/time indication field for indicating the date/time of each received or transmitted EDI file by the EDI platform.

3. The method of claim 1, wherein in said step (3), the predetermined time length is 2 hours.

4. The method of claim 1, wherein in said step (3), the warning message is transferred in Email form to an Intranet system, and then via the Intranet system to a pre-specified group of workstations.

5. The method of claim 4, wherein the warning message is further transferred via a wireless network interface to a pre-specified group of portable communication devices.

6. The method of claim 5, wherein the portable communication devices are PDAs (Personal Digital Assistants).

7. An EDI platform fault warning system for use with an EDI platform for detecting whether the EDI platform operates normally, and in the event of a fault condition on the EDI platform, generating a warning message;
the EDI platform fault warning system comprising:
(a) an EDI file scanning module, which is capable of scanning an EDI file reception/sending record in the EDI platform at a preset interval to find the date/time of the most-recently received or transmitted EDI file by the EDI platform;
(b) a comparison module coupled to the EDI file scanning module for comparing the date/time of the most-recently received or transmitted EDI file against the current date/time to check whether the difference therebetween exceeds a predetermined time length; if YES, the comparison module generating a trigger signal; and
(c) a warning message sending module, which is capable of generating a warning message in response to the trigger signal from the comparison module.

8. The EDI platform fault warning system of claim 7, the data structure of the EDI file reception/sending record includes:
an incoming/outgoing indication field for indicating the incoming/outgoing nature of each received or transmitted EDI file by the EDI platform; and
a date/time indication field for indicating the date/time of each received or transmitted EDI file by the EDI platform.

9. The EDI platform fault warning system of claim 7, wherein the predetermined time length is 2 hours.

10. The EDI platform fault warning system of claim 7, wherein the warning message sending module is an Email server, which generates the warning message in Email form and transfers the Email warning message via an Intranet system to a pre-specified group of workstations.

11. The EDI platform fault warning system of claim 10, wherein the Email warning message is further transferred via a wireless network interface to a pre-specified group of portable communication devices.

12. The EDI platform fault warning system of claim 11, wherein the portable communication devices are PDAs (Personal Digital Assistants).

13. A data structure of EDI file reception/sending record for use in an EDI platform, which comprises
an incoming/outgoing indication field for indicating the incoming/outgoing nature of each received or transmitted EDI file by the EDI platform; and
a date/time indication field for indicating the date/time of each received or transmitted EDI file by the EDI platform.
